(19) United States
(12) Patent Application Publication
(10) Pub. No.: US 2015/0364288 A1
(43) Pub. Date: Dec. 17, 2015

(54) RADIATION GENERATING APPARATUS

(71) Applicant: Metal Industries Research & Development Centre, Kaohsiung (TW)

(72) Inventors: Yen-Chun Chen, Kaohsiung City (TW); Wei-Hung Shih, Kaohsiung City (TW); Yi-San Chang, Tainan City (TW); Tsung-Chih Yu, Tainan City (TW); Wen-Hsin Hsieh, Taipei City (TW); Ming-Hui Cheng, Kaohsiung City (TW); Ho-Chung Fu, Kaohsiung City (TW)

(21) Appl. No.: 14/596,220

(22) Filed: Jan. 14, 2015

(30) Foreign Application Priority Data
Jun. 11, 2014 (TW) 103120209

(51) Int. Cl. H01J 35/12; H01J 35/16

(52) U.S. Cl. CPC H01J 35/12; H01J 35/16; H01J 2235/1262; H01J 2235/1295

(57) ABSTRACT

A radiation generating apparatus includes a target base, a target, an electronic beam generating device, a tube, a tank, and a porous structure. The target is disposed on the target base. The electronic beam generating device is adapted to generate an electronic beam, and the electronic beam is emitted to the target to generate a radiation. The tube accommodates the target and the electronic beam generating device. The tank is connected to the target base and accommodates the tube. The porous structure is roundly disposed between the tank and the tube and contacts an inner wall of the tank and an outer wall of the tube. A cooling fluid flows through the porous structure to dissipate the heat of the porous structure.

### CROSS-REFERENCE TO RELATED APPLICATION

This application claims the priority benefit of Taiwan application serial no. 103120209, filed on Jun. 11, 2014. The entirety of the above-mentioned patent application is hereby incorporated by reference herein and made a part of this specification.

### FIELD OF THE INVENTION

The invention relates to a radiation generating apparatus, and in particular, to a radiation generating apparatus using an electronic beam to irradiate a target to generate radiation.

### DESCRIPTION OF RELATED ART

An X-ray tube is an image device capable generating X-rays, which can be applied in fields of industrial testing, medical diagnosis or medical treatment. Generally, the X-ray tube includes an electronic beam generating device and a target. The electronic beam generating device can be composed of a high-voltage power supplier and a tungsten filament. When the high-voltage power supplier supplies enough current to the tungsten filament, the tungsten filament generates an electronic beam, and the electronic beam is emitted to the target to generate the X-ray.

In the aforementioned operation process, most of the energy of the electronic beam emitted to the target is converted into heat, causing the temperature of the target to increase. Thus, under a high-power operation, the high-energy electronic beams that continuously strike the X-ray target may cause the X-ray target to overheat, which wears and decreases a service life of the X-ray target. Thus, how to effectively perform heat dissipation towards the target is an important research topic in this particular field.

### SUMMARY OF THE INVENTION

The invention is directed to a radiation generating apparatus, for preventing a target of the radiation generating apparatus from overheating.

The radiation generating apparatus of the invention includes a target base, a target, an electronic beam generating device, a tube, a tank, and a porous structure. The target is disposed on the target base. The electronic beam generating device is adapted to generate an electronic beam, and the electronic beam is emitted to the target to generate a radiation. The tube accommodates the target and the electronic beam generating device. The tank is connected to the target base and accommodates the tube. The porous structure is roundly disposed between the tank and the tube, and contacts an inner wall of the tank and an outer wall of the tube. A cooling fluid flows through the porous structure to dissipate the heat of the porous structure.

In an embodiment of the invention, a thermal conductive layer is included between the outer wall of the tube and the porous structure. The thermal conductive layer is contacted with the porous structure.

In an embodiment of the invention, the tank includes at least one cooling fluid inlet and at least one cooling fluid outlet. The cooling fluid flows into the tank through the cooling fluid inlet, and flows out of the tank through the cooling fluid outlet.

In an embodiment of the invention, the radiation generating apparatus further includes a temperature sensing element. The temperature sensing element is disposed at the cooling fluid inlet, for sensing a temperature of the cooling fluid.

In an embodiment of the invention, the radiation generating apparatus further includes a temperature sensing element. The temperature sensing element is disposed at the cooling fluid outlet, for sensing a temperature of the cooling fluid.

In an embodiment of the invention, the radiation generating apparatus further includes a temperature sensing element. The temperature sensing element is disposed on the target base, for sensing a temperature of the target base.

In an embodiment of the invention, the target base includes a first surface and a second surface opposite to each other. The first surface faces the electronic beam generating device, the target is disposed on the first surface, and the temperature sensing element is disposed on the second surface.

In an embodiment of the invention, the tank includes a partition structure. The partition structure divides the tank into an inner region and an outer region. The outer region surrounds the inner region. The porous structure is located in the inner region. The partition structure includes at least one opening. The cooling fluid flows from the inner region to the outer region through the opening.

In an embodiment of the invention, the target is an X-ray target, and the radiation is an X-ray.

In an embodiment of the invention, the radiation penetrates through the target base to be emitted out.

Based on the above, the radiation generating apparatus includes a porous structure surrounding the tube and contacting the tank, and the cooling fluid flows through the porous structure. The porous structure, by way of a plurality of holes of the porous structure, has a large contact area with the cooling fluid. This way, the heat transmitted from the target base to the porous structure can quickly depart from the porous structure through the cooling fluid. Thus, the heat dissipation of the target base is effectively improved, so as to prevent the target from overheating, further lengthening the service life of the target.

To make the above features and advantages of the invention more comprehensible, several embodiments accompanied with drawings are described in detail as follows.

### BRIEF DESCRIPTION OF THE DRAWINGS

FIG. 1 is a schematic diagram of a radiation generating apparatus according to an embodiment of the invention.

FIG. 2 is a partially enlarged schematic diagram of the radiation generating apparatus of FIG. 1.

FIG. 3 is a schematic diagram of a radiation generating apparatus according to another embodiment of the invention.

### DESCRIPTION OF EMBODIMENTS

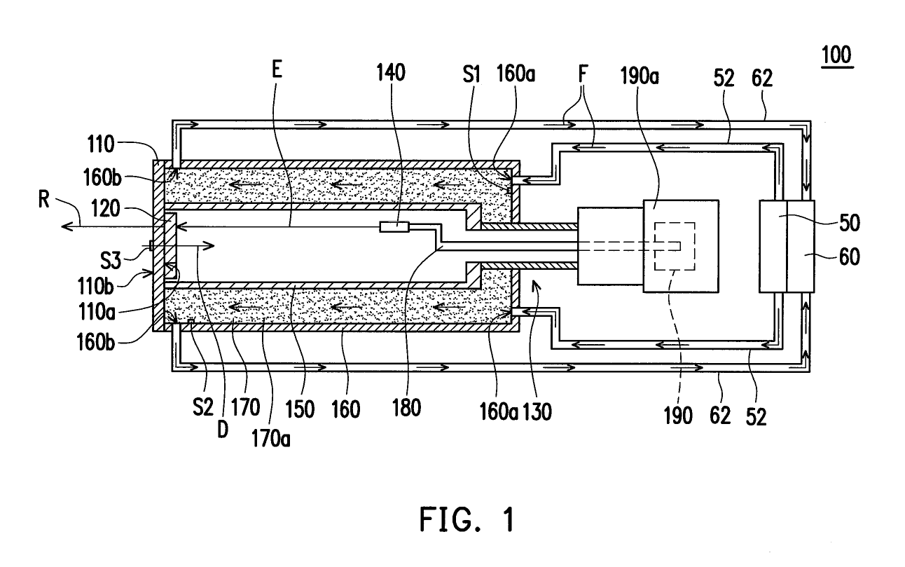

FIG. 1 is a schematic diagram of a radiation generating apparatus according to an embodiment of the invention. Referring to FIG. 1, the radiation generating apparatus 100 of the embodiment is, for example, a transmission type X-ray tube applied in fields of industrial testing, medical diagnosis or medical treatment. The radiation generating apparatus 100 includes a target base 110, a target 120, a holding assembly 130, an electronic beam generating device 140, a tube 150, a tank 160, and a porous structure 170. The tube 150 is, for example, a vacuum tube suitable for the X-ray tube, and the holding assembly 130 is partially disposed in the tube 150 and holds the target base 110. The target 120 is, for example, an X-ray target, and is disposed on the target base 110. The electronic beam generating device 140 is adapted to generate an electronic beam E. The electronic beam E is emitted to the target 120 along an axial direction D of the holding assembly 130, to generate a radiation R such as an X-ray. The radiation R penetrates through the target base 110 to be emitted out.

In detail, the tube 150 accommodates the target 120 and the electronic beam generating device. The tank 160 is connected to the target base 110 and accommodates the tube 150. The tank 160 is, for example, integrally formed and connected with the target base 110. The porous structure 170 is roundly disposed between the tank 160 and the tube 150, and contacts an inner wall of the tank 160 and an outer wall of the tube 150. The heat of the target base 110 is transmitted to the porous structure 170 through the tank 160. A cooling fluid F is adapted to flow through the porous structure 170 so as to perform heat dissipation towards the porous structure 170. In the embodiment, the porous structure 170 includes a plurality of holes 170a. A material of the porous structure 170 is, for example, a metal material with high thermal conductivity or other suitable materials. The invention is not limited thereto. In addition, the cooling fluid F of the embodiment is, for example, water, cooling oil, environmental refrigerant, liquid carbon dioxide, liquid oxygen, liquid nitrogen, or other suitable cooling fluids. The invention is not limited thereto.

Based on the above configuration, the radiation generating apparatus 100 includes the porous structure 170 disposed around the tube 150 and contacting the tank 160. The cooling fluid F flows through the porous structure 170. The porous structure 170, by way of the plurality of holes 170a of the porous structure 170, and has a large contact area with the cooling fluid F. This way, the heat transmitted from the target base 110 to the porous structure 170 can quickly depart from the porous structure 170 through the cooling fluid F. Thus, the heat dissipation of the target base 110 is effectively improved, so as to prevent the target 120 from overheating, further lengthening the service life of the target 120.

In the embodiment, the tank 160 includes at least one cooling fluid inlet 160a (two are shown in the figures) and at least one cooling fluid outlet 160b (two are shown in the figures). The cooling fluid F is suitable to flow into the cooling fluid inlet 160a from a pump 52 and through a piping 52. This way, the heat from the porous structure 170 can be transmitted of the cooling fluid F. After the heat from the porous structure 170 is transmitted to the cooling fluid F, the cooling fluid F flows to the tank 160 through the cooling fluid outlet 160b. Then, through a piping 62, the cooling fluid F flows to a heat exchanger 60 to undergo heat exchanging, and is then cycled back to the pump 50.

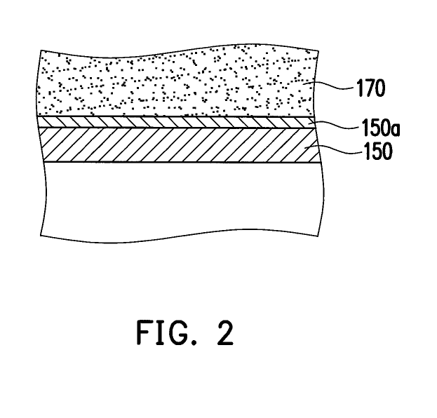

FIG. 2 is a partially enlarged schematic diagram of the radiation generating apparatus of FIG. 1. Referring to FIG. 2, in the embodiment, a thermal conductive layer 150a is, for example, included between the outer wall of the tube 150 and the porous structure 170. The thermal conductive layer 150a is contacted with the target base 110 (shown in FIG. 1) and the porous structure 170. This way, the heat from the target base 110 can be transmitted to the porous structure 170 through the thermal conductive layer 150a, so as to further improve the heat dissipation efficiency of the target base 110. The thermal conductive layer 150a is, for example, a metal coating layer with high thermal conductivity or other suitable materials. The invention is not limited thereto.

Please refer to FIG. 1. In the embodiment, the radiation generating apparatus 100 includes a temperature sensing element S1 and a temperature sensing element S2. The temperature sensing element S1 and the temperature sensing element S2 are respectively disposed at the cooling fluid inlet 160a and the cooling fluid outlet 160b. This way, the temperature of the cooling fluid F at the cooling fluid inlet 160a and the cooling fluid outlet 160b can be sensed, so as to determine if the temperatures are within a predetermined range. Thus, it can be determined if the cooling fluid F can adequately perform heat dissipation towards the target base 110. In addition, the radiation generating apparatus 100 further includes a temperature sensing element S3. The temperature sensing element S3 is disposed on the target base 110, so as to sense the temperature of the target base 110. This way, it can be determined if the target base 110 has overheated.

In the embodiment, the target base 110 includes a first surface 110a and a second surface 110b. The first surface 110a faces the electronic beam generating device 140. The target 120 is disposed on the first surface 110a of the target base 110, so as to be struck by an electronic beam E generated by the electronic beam generating device 140. The temperature sensing element S3 is then disposed on the second surface 110b of the target base 110, and is not struck by the electronic beam E generated by the electronic beam generating device 140.

In other embodiments, only one or two of the temperature sensing element S1, the temperature sensing element S2, and the temperature sensing element S3 may be disposed, or no temperature sensing elements are disposed. The invention is not limited thereto.

As seen in FIG. 1, in the embodiment, the target 120, the holding assembly 130, and the electronic beam generating device 140 are all disposed on a same side of the target base 110 (shown as the right side of the target base 110), and are not respectively disposed on two opposite sides of the target base 110. This way, the volume of the radiation generating apparatus 100 can be effectively reduced, so as to not take up space and satisfy user needs.

In the embodiment, the radiation generating apparatus 100 further includes a power supply unit 190 and a connecting element 180. The connecting element 180 is connected between the electronic beam generating device 140 and the power supply unit 190. The connecting element 180 supports the electronic beam generating device 140, and includes a circuit. The electronic beam generating device 140 is electrically connected to the power supply unit 190 through the circuit. The power supply unit 190 is, for example, disposed in a holding structure 190a. The holding structure 190a is fixed at a fixed end and is connected to the holding assembly 130, so as to support the holding assembly 130 and the target base 110.

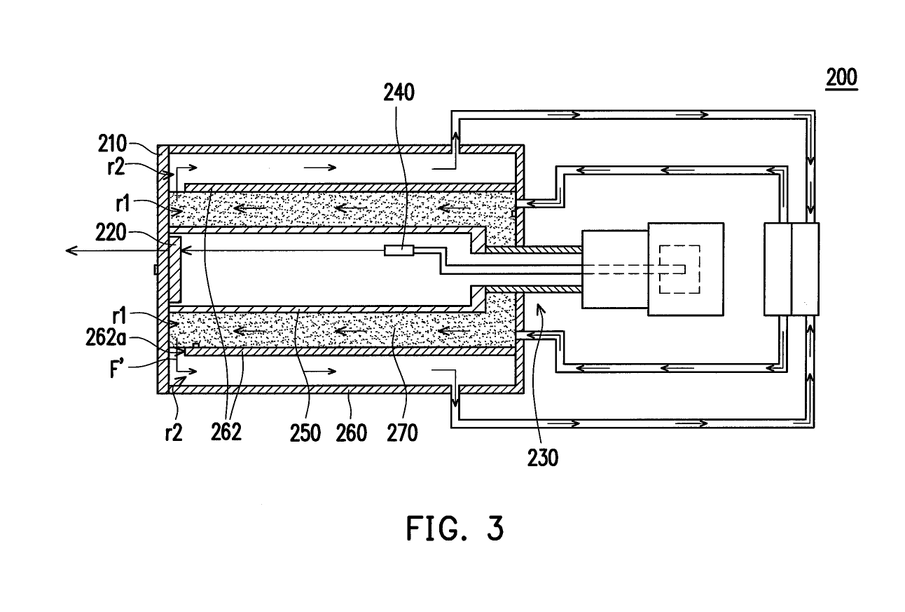

FIG. 3 is a schematic diagram of a radiation generating apparatus according to another embodiment of the invention. In the radiation generating apparatus 200 of FIG. 3, the target base 210, the target 220, the holding assembly 230, the electronic generating beam device 240, the tube 250, the tank 260, and the porous structure 270 is configured and utilized similar to the target base 110, the target 120, the holding assembly 130, the electronic generating beam device 140, the tube 150, the tank 160, and the porous structure 170 of FIG. 1. The details are not repeated herein. The difference between the radiation generating apparatus 200 and the radiation generating apparatus 100 is the tank 260 includes a partition structure 262. The partition structure 262 divides the tank 260 into an inner region r1 and an outer region r2. The outer region r2 surrounds the inner region r1. The porous structure 270 is located in the inner region r1. The partition structure 262 includes at least one opening 262a. A cooling fluid F′ flows from the inner region r1 to the outer region r2 to the opening 262a. Thus, the flow path of the cooling fluid F′ is increased, so that the cooling fluid F′ can adequately perform heat exchanging with the tank 260 and the partition structure 262. This way, the heat of the target base 210 can be quickly transmitted to the cooling fluid F′ through the tank 260 and the partition structure 262, further improving heat dissipation efficiency.

In the embodiment, an opening 262a is, for example, a single circular opening, surrounding the porous structure 270. However, the invention is not limited thereto. In other embodiments, a plurality of discontinuous openings can surround the porous structure 270.

To sum up, the radiation generating apparatus includes a porous structure disposed around the tube and contacting the tank, and the cooling fluid flows through the porous structure. The porous structure, by way of a plurality of holes of the porous structure, has a large contact area with the cooling fluid. This way, the heat transmitted from the target base to the porous structure can quickly depart from the porous structure through the cooling fluid. Thus, the heat dissipation of the target base is effectively improved, so as to prevent the target from overheating, further lengthening the service life of the target. In addition, a thermal conductive layer can be formed at an outer wall of the tube, contacting with the target base and the porous structure. This way, the heat from the target base can be transmitted to the porous structure through the thermal conductive layer, so as to further improve the heat dissipation efficiency of the target base. Furthermore, temperature sensing elements can be disposed at the cooling fluid inlet, the cooling fluid outlet, and the target base. By utilizing the temperature sensing elements, it can be determined if the cooling fluid can adequately perform heat dissipation towards the target base, and if the target base has overheated. In addition, a partition structure can be disposed in the tank so as to increase a flow path of the cooling fluid. This way, the cooling fluid can adequately perform heat exchanging between the tank and the partition structure, further improving heat dissipation efficiency.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A radiation generating apparatus, comprising:
a target base;
a target, disposed on the target base;
an electronic beam generating device, adapted to generate an electronic beam, wherein the electronic beam is emitted to the target to generate a radiation;
a tube, accommodating the target and the electronic beam generating device;
a tank, connecting to the target base and accommodating the tube; and
a porous structure, roundly disposed between the tank and the tube, and contacting an inner wall of the tank and an outer wall of the tube;
wherein a cooling fluid flows through the porous structure, so as to dissipate a heat of the porous structure.

2. The radiation generating apparatus as claimed in claim 1, wherein a thermal conductive layer is further included between the outer wall of the tube and the porous structure, and the thermal conductive layer is in contact with the porous structure.

3. The radiation generating apparatus as claimed in claim 1, wherein the tank includes at least one cooling fluid inlet and at least one cooling fluid outlet, and the cooling fluid flows into the tank through the cooling fluid inlet, and flows out of the tank through the cooling fluid outlet.

4. The radiation generating apparatus as claimed in claim 3, further comprising a temperature sensing element, wherein the temperature sensing element is disposed at the cooling fluid inlet, for sensing a temperature of the cooling fluid.

5. The radiation generating apparatus as claimed in claim 3, further comprising a temperature sensing element, wherein the temperature sensing element is disposed at the cooling fluid outlet, for sensing a temperature of the cooling fluid.

6. The radiation generating apparatus as claimed in claim 1, further comprising a temperature sensing element, wherein the temperature sensing element is disposed on the target base, for sensing a temperature of the target base.

7. The radiation generating apparatus as claimed in claim 6, wherein the target base includes a first surface and a second surface opposite to each other, the first surface faces the electronic beam generating device, the target is disposed on the first surface, and the temperature sensing element is disposed on the second surface.

8. The radiation generating apparatus as claimed in claim 1, wherein the tank includes a partition structure, the partition structure divides the tank into an inner region and an outer region, the outer region surrounds the inner region, the porous structure is located in the inner region, the partition structure includes at least one opening, and the cooling fluid flows from the inner region to the outer region through the opening.

9. The radiation generating apparatus as claimed in claim 1, wherein the target is an X-ray target, and the radiation is an X-ray.

10. The radiation generating apparatus as claimed in claim 1, wherein the radiation penetrates through the target base to be emitted out.
